(19) United States
(12) Patent Application Publication
(10) Pub. No.: US 2007/0102092 A1
(43) Pub. Date: May 10, 2007

(54) Method for manufacturing multilayer flexible circuits

(75) Inventors: John R. Dangler, Rochester, MN (US); Matthew S. Doyle, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(73) Assignee: International Business Machines Corporation, Armonk, NY (US)

(21) Appl. No.: 11/272,590

(22) Filed: Nov. 10, 2005

(51) Int. Cl. B32B 38/00; B32B 41/00

(52) U.S. Cl. 156/64; 156/356; 156/378

(57) ABSTRACT

A method for manufacturing multilayer flexible circuits is disclosed. The cross-sectional area of an unoccupied signal layer volume is initially determined. The unoccupied signal layer includes multiple conductive elements, and the unoccupied signal layer volume is formed between two of the conductive elements. Next, the thickness of an adhesive layer for filling the unoccupied signal layer volume is determined. Finally, the thickness of the adhesive layer is adjusted such that the adhesive layer only fills the unoccupied signal layer volume while the two conductive elements come in direct contact with a dielectric layer without any adhesive in between.

### BACKGROUND OF THE INVENTION

1. Technical Field

The present invention relates to flexible circuits in general. More particularly, the present invention relates a method for manufacturing multilayer flexible circuits. Still more particularly, the present invention relates to a method for manufacturing multilayer flexible circuits having reduced lossy materials.

2. Description of Related Art

Flexible transmission media, such as flexible circuits, are commonly used in electronic packaging. The base material used to manufacture flexible circuits is a base layer dielectric carrier film, typically made of polyimide with copper laminated on both sides of the film. For multilayer flexible circuits, the base layers are generally attached to each other by means of one or more adhesive layers. The formation of through-hole contacts and conductive patterns (on copper layers) is commonly accomplished by a subtractive process (i.e., etching) that is well-known to those skilled in the art. Outer layer conductors are subsequently provided with a protective covering film.

As switching speeds increase and attenuation requirements continue to restrict the content of transmission line material, it is increasingly desirable to use low-loss in flexible transmission media. Ridge printed circuit board constructs have an inherent loss limitation and variation due to woven glass weave content. However, flexible transmission media, by design, do not contain the same limitation because they do not contain such woven glass structures. Unfortunately, though, flexible transmission media do contain several electrically lossy layers known as adhesive.

The present disclosure provides an improved method for manufacturing multilayer flexible transmission media.

### SUMMARY OF THE INVENTION

In accordance with a preferred embodiment of the present invention, the cross-sectional area of an unoccupied signal layer volume is initially determined. The unoccupied signal layer includes multiple conductive elements, and the unoccupied signal layer volume is formed between two of the conductive elements. Next, the thickness of an adhesive layer for filling the unoccupied signal layer volume is determined. Finally, the thickness of the adhesive layer is adjusted such that the adhesive layer only fills the unoccupied signal layer volume while the two conductive elements come in direct contact with a dielectric layer without any adhesive in between.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a cross-section diagram of a multilayer flexible circuit, according to the prior art;

FIG. 2 is a high-level logic flow diagram of a method for manufacturing a multilayer flexible circuit, in accordance with a preferred embodiment of the present invention; and

FIG. 3 is a cross-section diagram of a multilayer flexible circuit, in accordance with a preferred embodiment of the present invention.

### DETAILED DESCRIPTION OF A PREFERRED EMBODIMENT

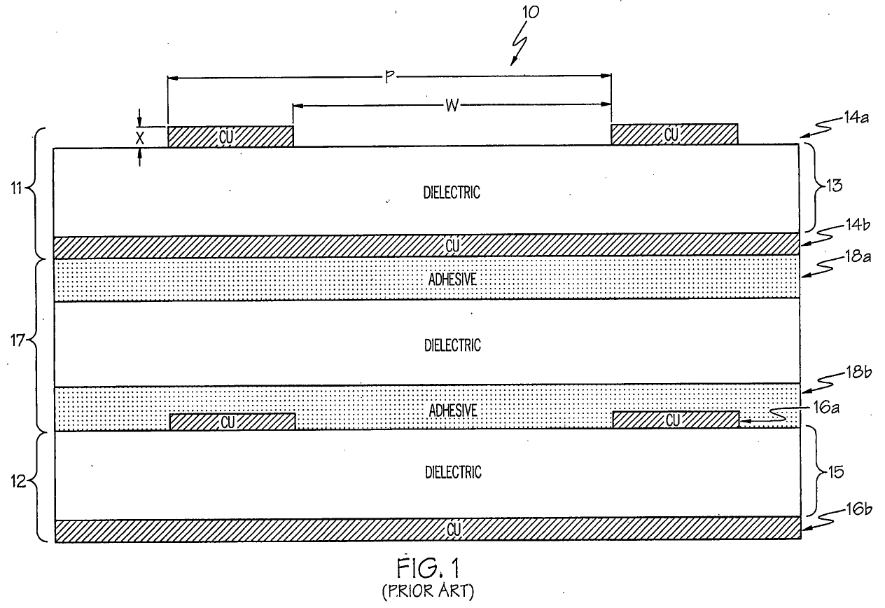

Referring now to the drawings, and specifically to FIG. 1, there is depicted a cross-section diagram of a multilayer flexible circuit, according to the prior art. As shown, a multilayer flexible circuit 10 includes a base layer 11 and a base layer 12. Base layer 11 includes a dielectric carrier film 13 laminated by copper layers 14a and 14b. Similarly, base layer 12 includes a dielectric carrier film 15 laminated by copper layers 16a and 16b. Dielectric carrier films 13 and 15 are typically made of polyimide. Base layers 11 and 12 are generally attached to each other by means of a bonding film 17 that includes adhesive layers 18a and 18b. The thickness of adhesive layers 18a and 18b are typically around 1 mil.

The performance of multilayer flexible circuit 30 can be improved by reducing the thickness of adhesive layers 18a and 18b. This is because an adhesive layer has a poor dissipation factor that increases attenuation within the overall dielectric medium. By reducing the amount of adhesive in the adhesive layer, the reliability and the attenuation properties of a multilayer flexible circuit can be improved.

The thicknesses of the adhesive layers should preferably be chosen so at the pitch of the signal lines and spaces such that the adhesive layers will just fill the area on the sides of the signal line. This eliminates the thick adhesive layer on the top of the signal lines.

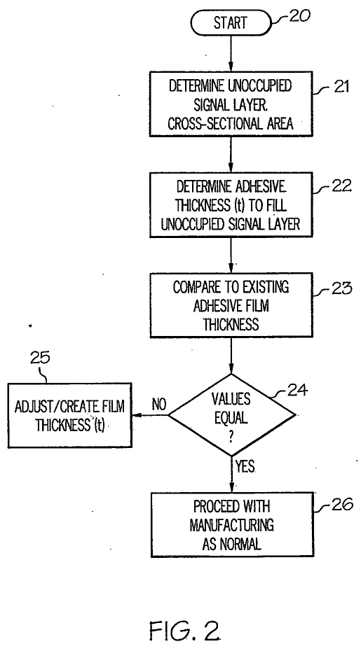

With reference now to FIG. 2, there is depicted a high-level logic flow diagram of a method for manufacturing a multilayer flexible circuit, in accordance with a preferred embodiment of the present invention. Starting at block 20, the cross-sectional area of an unoccupied signal layer volume is determined, as shown in block 21. The cross-sectional area of an unoccupied signal layer volume can be calculated by multiplying the height of a conductive element (x in FIG. 1) on a conductive layer (such as a copper layer) with the gap width (w in FIG. 1) between two conductive elements on the same conductive layer.

Then, an adhesive thickness for filling the unoccupied signal layer volume is determined, as depicted in block 22. The adhesive thickness for filling the unoccupied signal layer volume can be calculated by dividing the cross-sectional area of an unoccupied signal layer volume by a pitch. The pitch is defined to be the distance from a first edge of a first conductive element to a first edge of a second conductive element (p in FIG. 1).

The determined adhesive thickness is then compared to the existing adhesive film thickness, as shown in block 23. A determination is subsequently made as to whether or not the determined adhesive thickness is equal to the existing adhesive film thickness, as depicted in block 24. If the determined adhesive thickness is not equal to the existing adhesive film thickness, the thickness of the adhesive film is adjusted, as shown in block 25. Otherwise, if the determined adhesive thickness is equal to the existing adhesive film thickness, the multilayer flexible circuit is manufactured as usual, as depicted in block 26.

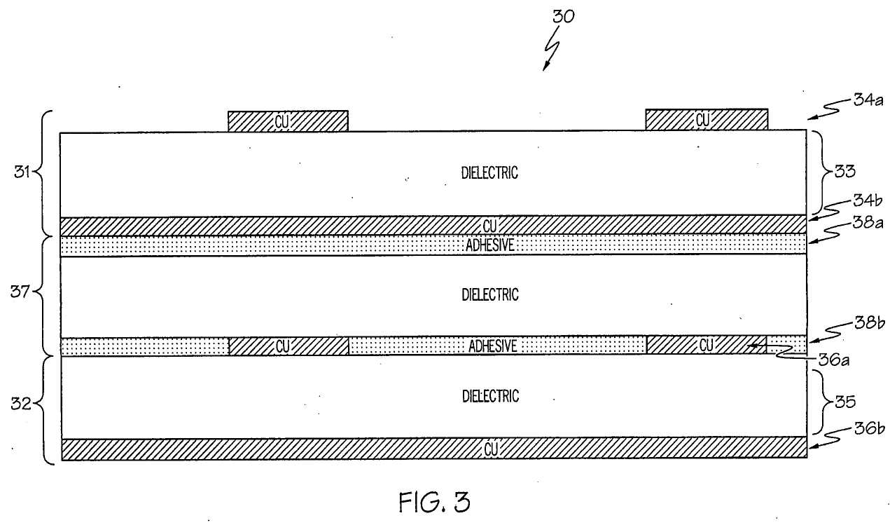

Referring now to FIG. 3, there is depicted a cross-section diagram of a multilayer flexible circuit, in accordance with a preferred embodiment of the present invention. As shown, a multilayer flexible circuit 30 includes a base layer 31 and a base layer 32. Base layer 31 includes a dielectric carrier film 33 laminated by copper layers 34a and 34b. Similarly, base layer 31 includes a dielectric carrier film 35 laminated by copper layers 36a and 36b. Dielectric carrier films 33 and 35 are preferably made of polyimide. Base layers 31 and 32 are attached to each other by means of a bonding film 37 that includes adhesive layers 38a and 38b. Preferably, the thickness of adhesive layers 38a and 38b are approximately 0.5 mil or less.

For the present embodiment, signal lines and spaces and adhesive thickness are chosen to only allow for 100% (or a number higher but very close to 100%) fill of adhesive on both sides of the signal lines. For example, on a ½ ounce signal line, 4 mil lines and 10 mil traces are chosen. ½ rail adhesive is chosen on the adhesive layer to attach the signal/ground layers together. The ½ mil adhesive flows to fill the 10 mil wide×0.7 rail wide void. The adhesive volume (½ mil×14 mil total pitch) is correct to fill the void. The thinner adhesive layers and natural stop of the signal line pushing past the adhesive layer of the adhesive film into the dielectric layer to provide a more uniform dielectric gap.

The resulting multilayer flexible circuit structure has a reduced amount of lossy/high material in the Z axis, and provides mostly low loss material on the top and bottom of the signal lines. The proper adhesive fill is calculated for each structure and ground reference design such that standard materials can be utilized to provide improvements in overall attenuation and reliability.

As has been described, the present invention provides an improved method for manufacturing multilayer flexible circuits having reduced lossy materials.

While the invention has been particularly shown and described with reference to a preferred embodiment, it will be understood by those skilled in the art that various changes in form and detail may be made therein without departing from the spirit and scope of the invention.

What is claimed is:

1. A method for manufacturing a multilayer flexible circuit, said method comprising:
determining a cross-sectional area of an unoccupied signal layer volume, wherein said unoccupied signal layer includes a plurality of conductive elements, wherein said unoccupied signal layer volume is formed between two of said plurality of conductive elements;
determining a thickness of an adhesive layer for filling said unoccupied signal layer volume; and
adjusting said thickness of said adhesive layer such that said adhesive layer only fills said unoccupied signal layer volume while said two of said plurality of conductive elements come in direct contact with a dielectric layer without any adhesive in between.

2. The method of claim 1, wherein said cross-sectional area of said unoccupied signal layer volume is determined by multiplying a height of one of said plurality of conductive elements with a gap width between said two of said plurality of conductive elements.

3. The method of claim 2, wherein said thickness of said adhesive layer is determined by dividing said determined cross-sectional area of said unoccupied signal layer volume by a pitch.

4. An apparatus for manufacturing a multilayer flexible circuit, said apparatus comprising:
means for determining a cross-sectional area of an unoccupied signal layer volume, wherein said unoccupied signal layer includes a plurality of conductive elements, wherein said unoccupied signal layer volume is formed between two of said plurality of conductive elements;
means for determining a thickness of an adhesive layer for filling said unoccupied signal layer volume; and
means for adjusting said thickness of said adhesive layer such that said adhesive layer only fills said unoccupied signal layer volume while said two of said plurality of conductive elements come in direct contact with a dielectric layer without any adhesive in between.

5. The apparatus of claim 4, wherein said means for determining a cross-sectional area further includes means for multiplying a height of one of said plurality of conductive elements with a gap width between said two of said plurality of conductive elements.

6. The apparatus of claim 5, wherein said means for determining a thickness further includes means for dividing said determined cross-sectional area of said unoccupied signal layer volume by a pitch.
